(19) United States
(12) Patent Application Publication
(10) Pub. No.: US 2021/0356114 A1
(43) Pub. Date: Nov. 18, 2021

(54) DEVICE AND METHOD OF USING LIGHT PROJECTIONS FOR CROWD CONTROL AND SPACING

(71) Applicant: Gannett Fleming, Inc., Camp Hill, PA (US)

(72) Inventor: John S. MULLAN, Morganville, NJ (US)

(21) Appl. No.: 17/230,220

(22) Filed: Apr. 14, 2021

Related U.S. Application Data
(60) Provisional application No. 63/024,841, filed on May 14, 2020.

(51) Int. Cl. F21V 33/00; F21V 23/04; E01F 13/02

(52) U.S. Cl. CPC F21V 33/006; F21W 2111/02; E01F 13/028; F21V 23/0435

(57) ABSTRACT

A device and method to provide individuals or groups in a queue with guidance, via high resolution light, regarding positioning and advancement without the need of the individuals, groups or employees to touch anything or without the need to have any labor installing tape or signs.

### FIELD OF THE INVENTION

The present invention is directed to a device and method for the orderly positioning and movement of people using projected light. In particular, the invention is directed to a device and method of assisting in social distancing and the logistics of efficiently and safely, guiding people in, through and out, of almost any type of facility indoors or outdoors.

### BACKGROUND OF THE INVENTION

In many venues, such as entertainment events, sporting events, public events, and transportation hubs, orderly movement of people, including “queuing” individuals or groups, is traditionally accomplished by physical barriers, such as stanchions or other types of barriers. While the barriers define areas for crowds to gather or queues to form, the barriers so not provide any guidance on proper distancing of the individuals in the crowd or the queue.

Recently, there has become a need to implement procedures to increase social distancing and reduce direct contact between individuals. In order to accomplish the distancing, visual reminders of appropriate spacing are physically positioned on floors or reminder signs are placed on walls and the like. While these physical reminders are helpful, the positioning of the reminders must be physically changed at configuration of the queue changes or as the guidelines with respect to appropriate spacing between individuals changes.

It would, therefore, be beneficial to provide a device and method of assisting in social distancing and efficiently and safely, guiding people in, through and out, of almost any type of facility indoors or outdoors without the need to position physical reminders or guides. It would also be beneficial to provide a device and method which could be easily changed according to the particular need and application.

### SUMMARY OF THE INVENTION

An object is to provide individuals or groups in a queue with guidance, via high resolution light, regarding positioning and advancement without the need of the individuals, groups or employees to touch anything or without the need to have any labor installing tape or signs.

An object is to provide individuals or groups in a crowd or queue with enhanced animated visual of a laser to stay and move as the line moves.

An object is to provide a system, device and method of assisting in social distancing and efficiently and safely, guide people in, through and out, of almost any type of facility indoors or outdoors without the need to position physical reminders or guides.

An object is to provide a system, device and method which is easily changed or programmed according to the particular need, guidelines and/or application.

An embodiment is directed to a system or device for efficiently and safely guiding people in, through and out, of an indoor or outdoor facility. The system includes a lighting device which projects geospatial lighting display lines to guide the people.

An embodiment is directed to a system for efficiently and safely guiding people in, through and out, of an indoor or outdoor facility. The system includes one or more lighting devices which project geospatial laser display lines to guide the people and space the people in queue.

An embodiment is directed to a method for efficiently and safely guiding people in, through and out, of an indoor or outdoor facility. The method includes: projecting geospatial lighting display lines from one or more lighting devices to guide the people; and spacing the geospatial lighting display lines to space the people in queue.

Other features and advantages of the present invention will be apparent from the following more detailed description of the illustrative embodiment, taken in conjunction with the accompanying drawings which illustrate, by way of example, the principles of the invention.

### BRIEF DESCRIPTION OF THE DRAWINGS

FIG. 1. Is a diagrammatic perspective view of an illustrative embodiment of the invention of using laser lights to control the spacing of individuals in a queue, in this illustrative embodiment, the lasers are attached to physical items provided proximate the queue.

FIG. 2A is an enlarged perspective view of the laser attached to a stanchion.

FIG. 2B is an enlarged perspective view of the laser attached to a retractable belt.

FIG. 3 is a diagrammatic perspective view of an illustrative embodiment of the invention of using laser lights to control the spacing of individuals in an area or queue, in this illustrative embodiment, the laser(s) is attached to a structure, such as a ceiling.

FIG. 4 is a diagrammatic perspective view of an illustrative embodiment of the invention of using laser lights to control the spacing of individuals in an area or queue, in this illustrative embodiment, the laser(s) is attached to a movable object, such as a drone.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

The controlled positioning and movement of individuals and groups through a queue or in a crowd is often desirable. This is particularly true when the health and safety of the individuals is at risk, such as during a pandemic. Consequently, assisting in social distancing and efficiently and safely, guiding people in, through and out, of almost any type of facility indoors or outdoors, is important. This requires facility operator/owners to provide a safe and improved passage throughout their facilities, resulting in an increase demand for effective and efficient crowd control devices.

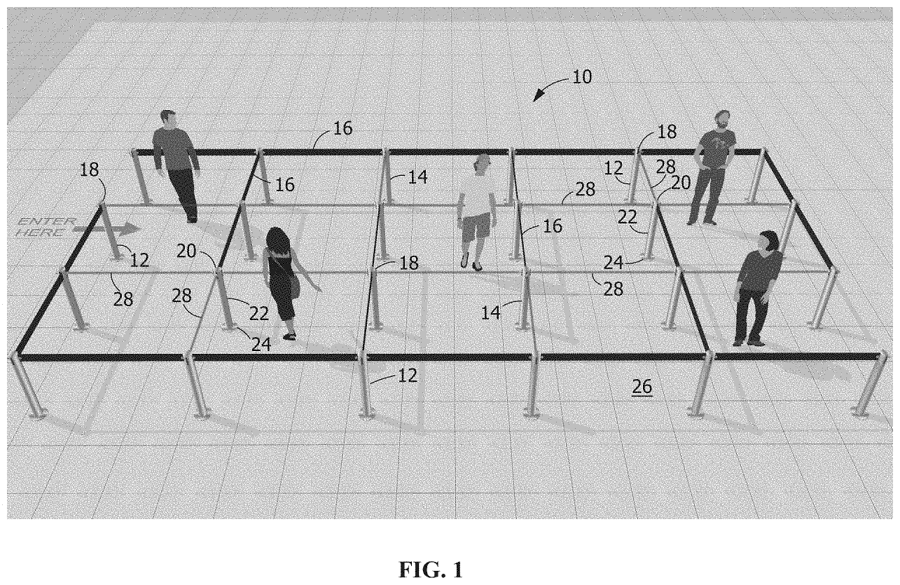

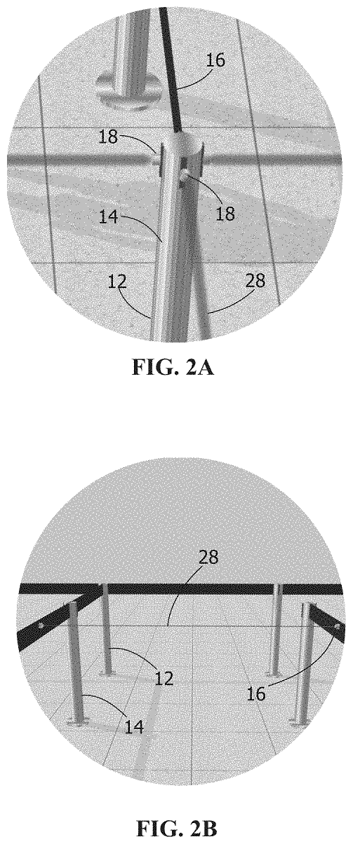

As shown in FIG. 1, an illustrative system 10 for controlling the spacing of individuals in an area or queue is shown. The system 10 includes physical barriers 12, such as stanchions 14 and retractable belts 16. As shown in FIGS. 2A and 2B, lighting devices or lasers 18 may be mounted on the stanchions 14 or on the retractable belts 16. In various illustrative embodiments, the lasers 18 may be mounted in the stanchion head 20, the stanchion stake 22 or the stanchion base 24. In various other illustrative embodiments, the lasers 18 may be mounted in the retractable belts 16 of replacement belts (not shown). In other illustrative embodiments, the lighting devices 18 may be mounted on a wall (not shown).

Regardless of the embodiment, the lighting devices 18 are programmed to project light onto a surface 26 or between the space between physical barriers 12 to project geospatial laser display lines or grids 28 to properly space individuals, such as to meet the need for social distancing. Alternatively, or in addition, the devices 18 may display text and symbols for pedestrian wayfinding directions throughout the controlled social distancing environment. Such text and/or symbols that are projected may include, but are not limited to, enter access signage, directional flow arrows, stop here text, ADA access symbols.

The physical barriers 12 can be, but are not limited to, the stanchions 14 and belts 16, as described above. Physical barriers 12 may be, but are not limited to, free standing retractable barriers, adjustable length crowd control barriers, caution message barriers, safety retracting belt barriers and double tape posts.

The lighting devices 18 may be included in new physical barriers 12 or may be retrofitted into existing physical barriers 12, such as any part of the existing stanchion 14 or wall mount. The lighting devices 18 may be high resolution LED laser light which can project across the area of interest to demonstrate appropriate or desired space planning and social distance between individual or groups in the queue or area. While the illustrative embodiment is shown and described with the use of lasers 18, other types of lighting devices may be used without departing from the scope of the invention. The lighting device 18 may be battery operated and form a portable part of the system 10, similar to any other component of the system 10.

As described, the lighting device 18 are easily adaptable to any part of the system 10 including but not limited to the stanchion head 20, the stanchion stake 22 or the stanchion base 24 or the retractable belt 16. For example, the lighting devices 18 could be positioned at designated intervals (e.g., 2′ intervals) along the length of the belt 16.

The lighting devices 18 may have a controller (not shown) which allows the lighting devices 18 to be programmable. The physical barriers 12 and the lighting devices 18 may be set up in any configuration and practically anywhere desired for an event. Once the setup is completed, the lasers 18 may be controlled through an app on a handheld phone device or the like.

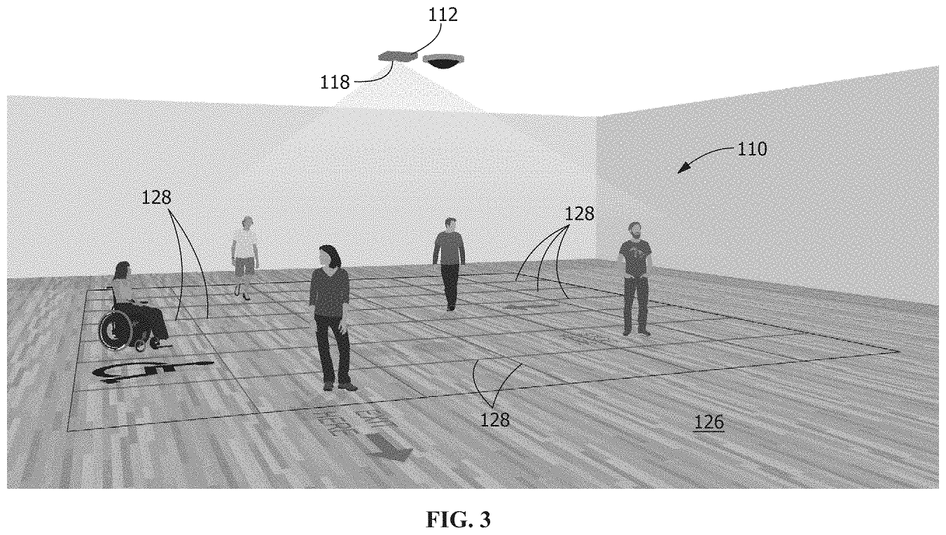

As shown in FIG. 3, a second illustrative system 110 for controlling the spacing of individuals in an area or queue is shown. The system 110 includes a mounted device 112. The mounted device 112 may be mounted to a horizontal surface (such as, but not limited to, a ceiling of a structure), a vertical surface (such as, but not limited to, a wall of a structure), or a sloped surface. Lasers or other lighting devices 118 may be positioned on or in the ceiling mounted device 112. In various illustrative embodiments, the lighting devices 118 may be mounted in other areas such as, but not limited to, security eyeballs, elevated security gates, or light posts.

Regardless of the embodiment, the lighting devices 118 are programmed to project light onto a surface 126 to project geospatial laser display lines or grids 128 to properly space individuals, such as to meet the need for social distancing. Alternatively, or in addition, the devices 118 may display text and symbols for pedestrian wayfinding directions throughout the controlled social distancing environment. Such text and/or symbols that are projected may include, but are not limited to, enter access signage, directional flow arrows, stop here text, ADA access symbols.

The lighting devices 118 may be high resolution LED laser light which can project across the area of interest to demonstrate appropriate or desired space planning and social distance between individual or groups in the queue or area. The lighting device 118 may be hard wired or may be battery operated and form a portable part of the system 110.

The lighting devices 118 may have a controller (not shown) which allows the lighting devices 118 to be programmable. The lighting devices 118 may be set up or installed at different place on in different configurations which is desired for the area of for an event. Once the setup is completed, the lighting devices 118 may be controlled through an app on a handheld phone device or the like.

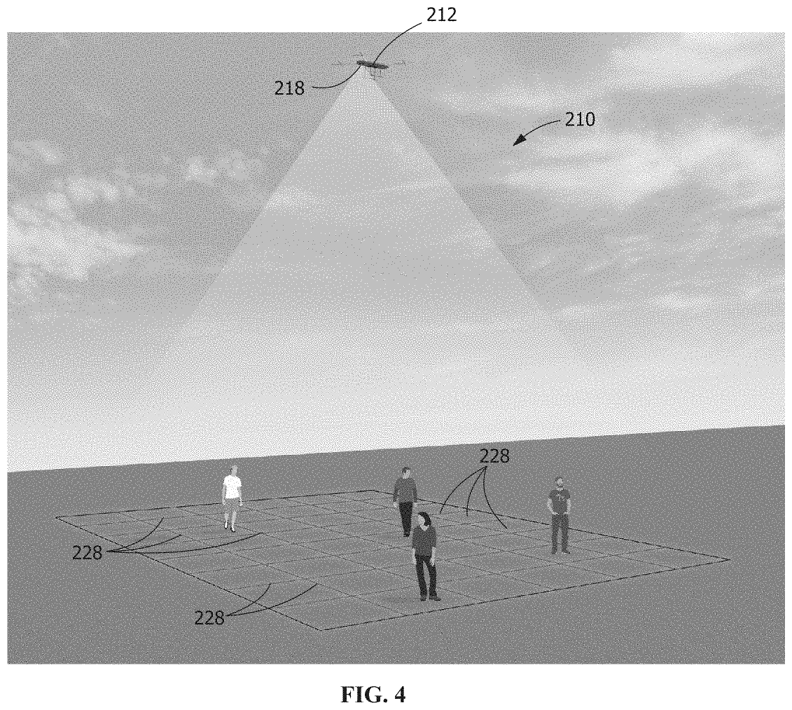

As shown in FIG. 4, a third illustrative system 210 for controlling the spacing of individuals in an area or queue is shown. The system 210 includes a lasers or other lighting devices 218 positioned on or in the drone or movable object or device 212.

Regardless of the embodiment, the lighting devices 218 are programmed to project light onto a surface 226 to project geospatial laser display lines or grids 228 to properly space individuals, such as to meet the need for social distancing. Alternatively, or in addition, the devices 218 may display text and symbols for pedestrian wayfinding directions throughout the controlled social distancing environment. Such text and/or symbols that are projected may include, but are not limited to, enter access signage, directional flow arrows, stop here text, ADA access symbols.

The lighting devices 218 may be high resolution LED laser light which can project across the area of interest to demonstrate appropriate or desired space planning and social distance between individual or groups in the queue or area. The lighting device 218 may be battery operated and form a portable part of the system 210.

The lighting devices 218 may have a controller (not shown) which allows the lighting devices 218 to be programmable. The drone or movable device 212 and the lighting devices 218 may be moved and positioned at a location which is desired for the area of for an event. Once positioned properly, the lighting devices 118 may be controlled through an app on a handheld phone device or the like. In addition, the position of the drone or movable device 212 and the lighting devices 218 may be altered or moved to accommodate the movement of the individual or groups in the queue or area.

The lighting devices 18, 118, 218 of the systems 10, 110, 210, as illustrated in FIGS. 1, 3 and 4, can be programmed to display geospatial display lines or grids 28, 128, 228 at whatever distance is desired or required, for example to provide whatever social spacing is desired in square or rectangle configurations based on certain key metrics. For example, the geospatial display lines or grids 28, 128, 228 may be programmed to distance individual or groups at 2′, 4′, 6′, 8′, or 10′ intervals. Alternatively, the geospatial display lines or grids 28, 128, 228 may be programmed based on the number of individuals are desired in a specific queue or area.

In use, as the customer is in display geospatial display lines or grids 28, 128, 228 of the crowd control environment, the customer or group of customers simply advances as an individual or group through the high resolution light without touching anything or without the need to have any labor installing tape or signs. Instead, the individual or group receives an enhanced animated visual of light to stay and move as the line moves.

The device and method as described and claimed herein can be used in many different types of locations and many different types of facilities, including, but not limited to: any industry attracting, managing or servicing large amount of people, passengers, riders, event participants, fan, etc.; or host facilities which attract, support or serve large number of people and need to queue people fora purpose. In particular, the locations or facilities may use the device and method can be used at locations, such as, but not limited to: access point (for example egress/ingress & through the facility); security checkpoints; concession/comfort areas; food courts; and/or restrooms.

Examples of particular locations include, but are not limited to: aviation (ticket check in, courtesy desk or kiosk, luggage drop off, safety & security checkpoints, gate/boarding area); transit rail (ticket purchase, fare turn-style, platform waiting); transit bus (bus passenger pickup depot/stations, waiting & onboarding daily commuter; departure from major bus passenger terminals); entertainment/sporting/major public events (ticket purchase, entrance, security checkpoints, concession areas; and/or restrooms); political events (voting lines, campaign rallies, fund raisers); and education (orientations, performances, graduation ceremonies).

The device is used in a method for efficiently and safely, guiding people in, through and out, of almost any type of facility indoors or outdoors without the need to position physical reminders or guides. The lights are projected from the device to display geospatial laser display lines or grids to properly space individuals. The lights are programmable to allow the lights to display different geospatial laser display lines or grids as desired.

The device and method as described and claimed herein can be used for many divergent purposes, including, but not limited to: safety & security; social distancing; pedestrian spacing; crowd control; people movement; people onboarding or passing thru a facility or area; efficiencies and logistics; time demand; customer comfort/confidence; human health preservation; and/or risk abatement to injury or accident.

The device and method as described and claimed herein improves quality and assurance to the general public in queuing people, space planning, movement of the individual and groups of people by quality controlling the environment and assuring social distancing throughout the entire process.

When properly used, the device and method as described and claimed herein will likely reduce risk and limit liability to facility owners, while facilitating social distancing, thereby also helping to reduce risk of injury and accidents resulting in increased consumer confidence.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A system for efficiently and safely guiding people in, through and out, of an indoor or outdoor facility, the system comprising:
a lighting device which projects geospatial lighting display lines to guide the people.

2. The system as recited in claim 1, wherein the lighting device is a laser.

3. The system as recited in claim 1, wherein the lighting device is positioned on a physical barrier.

4. The system as recited in claim 3, wherein the barrier is movable.

5. The system as recited in claim 4, wherein the barrier is a stanchion head, the lighting device projects the geospatial lighting display lines to properly space the people in queue.

6. The system as recited in claim 4, wherein the barrier is a retractable belt, the lighting device projects the geospatial lighting display lines to properly space the people in queue.

7. The system as recited in claim 1, wherein the lighting device is positioned on a fixed structure.

8. The system as recited in claim 6, wherein the lighting device is positioned on a horizontal surface of the fixed structure.

9. The system as recited in claim 6, wherein the lighting device is positioned on a vertical surface of the fixed structure.

10. The system as recited in claim 6, wherein the lighting device projects text or symbols to properly guide the people.

11. The system as recited in claim 1, wherein the lighting device is positioned on a movable object.

12. The system as recited in claim 11, wherein the movable object is a drone.

13. The system as recited in claim 1, wherein the lighting device has a controller which allows the lighting device to be programmable.

14. The system as recited in claim 13, wherein the lighting device is controlled through an app on mobile device.

15. The system as recited in claim 13, wherein the lighting device projects light onto a surface.

16. A system for efficiently and safely guiding people in, through and out, of an indoor or outdoor facility, the system comprising:
one or more lighting devices which project geospatial laser display lines to guide the people and space the people in queue.

17. The system as recited in claim 16, wherein the one or more lighting devices are positioned on one or more stanchion heads or one or more belts at designated intervals.

18. The system as recited in claim 1, wherein the one or more lighting devices are positioned on one or more movable objects.

19. A method for efficiently and safely guiding people in, through and out, of an indoor or outdoor facility, the method comprising:
projecting geospatial lighting display lines from one or more lighting devices to guide the people;
spacing the geospatial lighting display lines to space the people in queue.

20. The method as recited in claim 19, comprising:
programming the one or more lighting devices to allow the one or more lighting devices to display different geospatial lighting display lines.
